(19) United States
(12) Patent Application Publication
(10) Pub. No.: US 2008/0231643 A1
(43) Pub. Date: Sep. 25, 2008

(54) Method and apparatus for controlling the size or opacity of map elements rendered in an interactive map view

(76) Inventors: Nick Fletcher, Beijing (CN); Paul Hallett, Beijing (CN); Shaohong Ai, Beijing (CN)

Correspondence Address: COATS & BENNETT, PLLC, 1400 Crescent Green, Suite 300, Cary, NC, 27518, US

(21) Appl. No.: 12/052,579

(22) Filed: Mar. 20, 2008

Related U.S. Application Data
(60) Provisional application No. 60/895,996, filed on Mar. 21, 2007.
(60) Provisional application No. 60/896,000, filed on Mar. 21, 2007.
(60) Provisional application No. 60/896,001, filed on Mar. 21, 2007.

(51) Int. Cl. G09G 5/00

(52) U.S. Cl. 345/661

(57) ABSTRACT

To provide the illusion of smooth motion during zoom or pan operations of an interactive map display, relatively unimportant map elements are not rendered during map movements. By reducing the number of elements to be rendered in each frame during the movement, a map display rendering engine can increase its frame rate, thus providing the illusion of smooth motion. At the completion of the zoom or pan operation, the omitted elements “fade in” by successively rendering the same frame with the omitted elements' opacity gradually increasing in each frame. The selection of map elements to omit during map movement is made by comparing a dynamic value stored with each layer of map elements to a rendering performance value, which may be based on the computational power of the rendering engine, and may be set upon installation of the map software.

This application claims priority to U.S. Provisional Patent Application Ser. No. 60/895,996, titled “Method and Apparatus for Selectively Rendering Map Elements When Panning or Zooming An Interactive Map View,” filed Mar. 21, 2007; U.S. Provisional Patent Application Ser. No. 60/896,000, titled “Method and Apparatus for Fading Map Elements In and Out When Zooming an Interactive Map View,” filed Mar. 21, 2007; and U.S. Provisional Patent Application Ser. No. 60/896,001, titled “Method and Apparatus for Expanding Map Names On Mouse Rollover,” filed Mar. 21, 2007, all three of which are incorporated herein by reference in their entirety.

### FIELD OF THE INVENTION

The present invention relates generally to map-display software and in particular to selectively controlling the size or opacity of map elements rendered in an interactive map view.

### BACKGROUND

An interactive map presented to a user by software is a very useful tool. The user can zoom in or out of the map to see more or less detail and less or more scope. While zoomed in, he can pan the map to change the displayed location. The map provides a moveable bird's eye view that gives the user a feeling of close control over the map and allows the user to frame exactly the area he wants to see.

Presenting such a map effectively is not a simple matter. A map is a collection of many map elements: geographic details such as roads, rivers, and parks; labels such as region names; and other geographic information. The rendering engine that draws the map on a display must read all of these elements and render them in a meaningful way to the user.

The user's specified zoom level determines much of what is displayed. When the user is zoomed in, the map shows more detail by rendering more map elements. When the user is zoomed out, the map shows less detail by rendering fewer map elements. This prevents element density that can make the map illegible.

A subjectively important aspect of a user's satisfaction in interacting with an interactive map is map motion—the time when a user is zooming or panning the map display. In order to give the user the illusion of motion, the engine quickly draws a series of map images, each slightly changed from the last, drawn in fast enough succession that the user doesn't see them as separate maps but as a single map in smooth motion.

The speed with which a rendering engine draws each frame of a moving map is determined for the most part by two factors: the power of the processor or computer on which the engine runs and the map's detail. Detail is determined by the number of map elements that the engine must render in a frame. If the computing power is not adequate for quickly drawing the amount of necessary detail in each frame, then the frame speed slows down until the illusion of motion is shattered and the user sees a series of still frames in a jerky and distracting attempt at motion.

An interactive map program cannot choose the type and power of the hardware on which it runs. In fact, many environments where interactive maps are most useful may be those in which only small, portable, low-power processors are available. Non-limiting examples include Personal Digital Assistants (PDAs), cellular telephones, GPS receivers, and the like.

To improve rendering speed at a given level of zoom, the program may reduce the number of map elements it has to render. Element reduction, though, reduces the amount of detail the user sees, and reducing map elements enough to ensure smooth motion at a zoom level can simplify a map so much that it is no longer much use to the user, especially when the map stops moving and the user looks for details. Accordingly, balancing the useful detail presented to the user with map frame rendering speed stands as a primary challenge to interactive map design.

As mentioned above, the details displayed on a map change as a function of the zoom level. As a user zooms out, details such as street names and features such as the identification of schools, churches, businesses, and the like are not displayed to avoid clutter that would make the map unreadable. However, simply turning features on as a user zooms in, and turning them off as he zooms out, degrades the subjective feeling of smooth motion that contributes to satisfactory user interaction with a map. The sudden appearance of a feature during a zoom operation—such as by simply displaying the feature or not as a function of the current zoom level—may startle the user, and disrupts the illusion of smooth motion that the rapid, successive rendering of frames achieves. Turning the display of features on and off as a function of zoom level while maintaining the illusion of smooth zoom motion is another challenge of interactive map design.

One type of feature, the display of which may depend on the zoom level, is a text label. Labels may identify street names, parks, schools, geographic features such as lakes, and the like. When a map is zoomed out, small map labels can be hard to read. A user may zoom the map in briefly to expand a label, read it, and then zoom back out again, but this process takes time and the user may lose his place in the map during the zooms. One solution to illegible small map labels is for the map player to magnify the small area of the visible map where the name occurs. However, this kind of magnification expands all map elements around the name and obscures much of the map under the magnified area, making it harder to comprehend the map. Also, if the map uses bit-mapped graphics, magnifying a section will show jagged pixels.

Another solution to small map labels is to temporarily increase the font size of a selected label. This is straightforward for interactive map systems that store text as a standard encoding, such as ASCII, and use fonts to display the text. When a user selects a label, the system simply increases the font size temporarily. However, this type of text display system is inflexible. Often, text labels are preferably curved or otherwise placed in odd positions to match the map elements they describe. For example, a long street name may overlie the street, and must follow curves in the street or it may not be clear with which street the label is associated. Such labels are typically encoded as vector-based graphics just as the other map elements are. They are drawn in the map just as other elements are and not displayed using a computer system's standard text display system. This makes it difficult to distinguish map text from other map elements and to then expand the text if desired.

### SUMMARY

According to one or more embodiments disclosed and claimed herein, relatively unimportant map elements are not rendered during map movements, i.e., zoom or pan operations. By reducing the number of elements to be rendered in each frame during the movement, a map display rendering engine can increase its frame rate, thus providing the illusion of smooth motion. At the completion of the zoom or pan operation, the omitted elements “fade in” by successively rendering the same frame with the omitted elements' opacity gradually increasing in each frame. The selection of map elements to omit during map movement is made by comparing a dynamic value stored with each layer of map elements to a rendering performance value, which may be based on the computational power of the rendering engine, and may be set upon installation of the map software.

In one embodiment, the illusion of smooth motion is further maintained during zoom operations by fading map elements in or out of the display is the zoom level changes, rather than elements suddenly appearing or disappearing. A plurality of zoom positions are defined, each including a plurality of layer specifiers for elements to be rendered at that zoom position. The layer specifiers include all map elements in the layer (i.e., all map elements to be rendered according to the same rules) and display parameters for the layer. The display parameters include an alpha value, which controls the opacity (or conversely, transparency) with which map elements in the layer are rendered. The alpha values in layer specifiers for a given layer are gradually changed over a transition zone comprising a plurality of zoom positions. In zooming to, through, and past the transition zone, the elements may initially not be rendered due to no layer specifiers in the zoom positions. Upon reaching and transiting the transition zone zoom positions, the elements are rendered in increasing opacity due to increasing alpha values. On the other side of the transition zone, the elements are rendered in full opacity due to a maximum alpha value.

In another embodiment, raster graphic text labels stored as map elements may also be expanded for easy viewing in a zoomed-out display. If a user hovers a mouse pointer over a small text label for a predetermined duration, the text label is expanded by rendering the map display again, with all elements rendered the same except for the text label, which is rendered larger but still centered at the small label's center. The text is reduced when the mouse pointer moves off the label by re-rendering the map display as before. In one embodiment, the text is not expanded if the mouse pointer is over a color that does not correspond to the text or the feature it labels, such as a road.

### BRIEF DESCRIPTION OF THE DRAWINGS

FIG. 1 is a functional block diagram of an interactive map system.

FIG. 2 is a functional block diagram of a map object data structure.

FIG. 3 is a functional block diagram of a configuration data structure.

FIG. 4 is a functional block diagram of a zoom scale data structure.

FIG. 5 is a functional block diagram of a layer specifier data structure.

FIG. 6 is a flow diagram of an initial map display procedure.

FIG. 7A-7B is a flow diagram of a moving map display procedure.

FIG. 8A-8B is a flow diagram of a stopped map display procedure.

FIG. 9 is diagram depicting the relationship between zoom position index and alpha value.

FIG. 10 is a functional block diagram of a text block data structure.

FIG. 11 is a functional block diagram of a text label data structure.

FIG. 12 is a representative rendering of a text label in a map.

FIG. 13 is a functional block diagram of a rendered text block list.

FIG. 14 is a flow diagram of detecting the need for a text expansion operation in a map display.

FIG. 14 is a flow diagram of expanding text in a map display.

### DETAILED DESCRIPTION

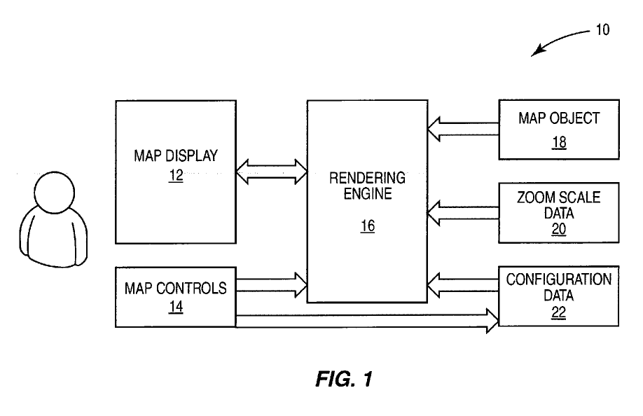

FIG. 1 illustrates the components of an interactive map system 10 that may be operated in accordance with one or more embodiments of the invention. A user runs an interactive map program on a computer that presents a map display 12 and a set of map controls 14 to the user. The user views the interactive map in the map display 12 and uses the map controls 14 to move the map in the display so that it presents information the user wants to view. Map motion may include zooming in (enlarging map elements while decreasing map coverage), zooming out (diminishing map elements while increasing map coverage), and panning (moving the map up, down, sideways, or a combination thereof to change the displayed location).

The program's rendering engine 16 draws (renders) map elements in the map display 16. It reads values from the map controls 14 so that it can respond to the user's input and move the map accordingly. It may also read information about the user's actions within the map display 12 such as moving a pointer over an element or clicking on an element.

The rendering engine 16 reads stored data that it uses to render a map in the map display 16. That data includes a map object 18 that contains information about map elements contained within the displayed map. The map object also contains information groupings of those elements (called layers) and how elements within those layers should be presented in the map display 16.

A second set of data is zoom scale data 20 that defines a series of zoom values along the full possible range of zoom presented by the rendering engine 16, from fully zoomed in to fully zoomed out. Each zoom value is accompanied by data defining how different layers defined in the map object 18 should be displayed at different levels of zoom. This data defines when layers appear or disappear during zoom or perform other zoom-level-specific actions. It also defines when layers should disappear or remain in place when a map moves by zooming or panning.

A third set of data, the configuration data 22, contains simple values that determine the rendering engine's 16 performance while rendering and how quickly it fades map elements in or out when it adds elements to or removes elements from the map display 12.

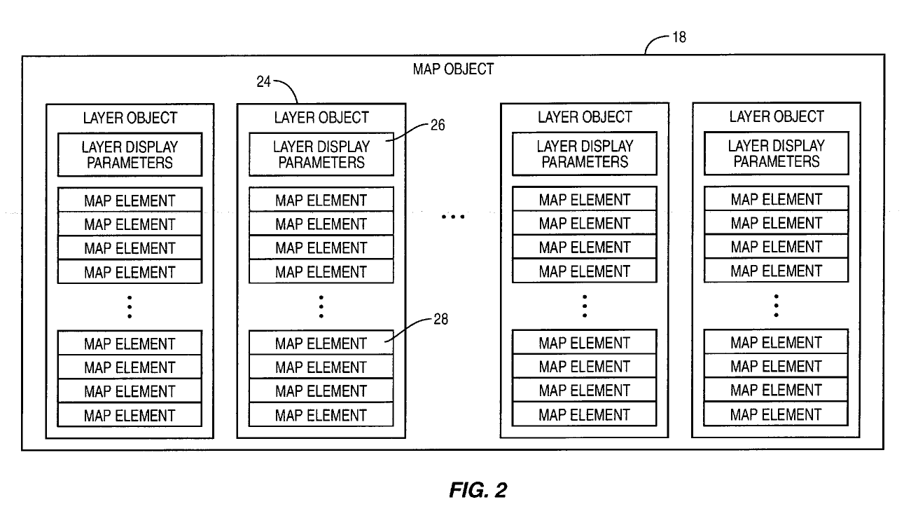

FIG. 2 illustrates the structure of data within a map object 18. The map object contains an array of one or more layer objects 24 that each describes a different layer of map elements.

Each layer object 24 contains a set of layer display parameters 26 that define how the rendering engine renders the map elements within that layer. Those parameters define rendering qualities such as the colors used to render the map elements.

Each layer object 24 also contains an array of one or more map elements 28 that each contains the data, in the form of closed and open sets of straight lines and curves, necessary to render the map element. Examples of map elements include roads, parks, shorelines, and road names that must curve to follow roads.

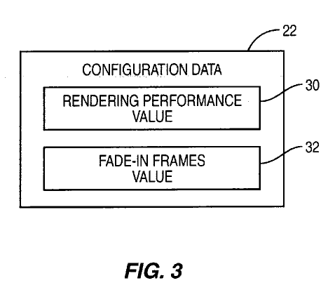

FIG. 3 illustrates the configuration data 22 that the rendering engine reads to determine some of the qualities it uses to render map images. The first of the configuration values is the rendering performance value 30 that the user may set using an interactive map control. In one embodiment of the invention it is a value from zero to nine. Zero specifies that the rendering engine should render all possible details in the map display at the possible cost of slowing down the frame rendering speed and disrupting the user's illusion of smooth motion. Nine specifies that the rendering engine should render the fewest meaningful details in the map display with the benefit of speeding up the frame rendering speed for the illusion of smooth motion.

The second of the configuration values is the fade-in frames value 32 that defines how many frames the rendering engine will take to fade in a hidden or diminished map element when map motion ceases. This value may be set when the interactive computer map program is installed on a computer.

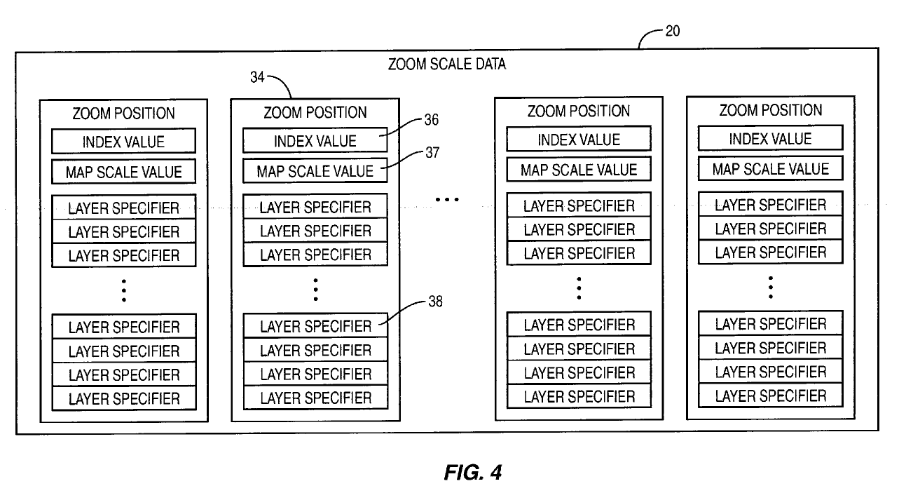

FIG. 4 illustrates the structure of data within zoom scale data 20. It is an array of zoom positions 34. Each zoom position contains a unique index value 36 used to quickly identify the zoom position. Each zoom position 34 also contains a map scale value 37 that defines a point along the scale of possible zoom values in the interactive map program. In one embodiment, map scale is measured in the number of meters represented across the horizontal axis of the map display.

The full set of zoom positions 34 describes a set of discrete zoom positions along the possible range of zoom values. In one embodiment of the invention there are 150 zoom positions 34 that are spread over the perceptible range of zoom. This allows the rendering engine to always find a zoom position 34 that is close the map's current zoom setting.

A zoom position 34 also contains an array of one or more layer specifiers 38. Each layer specifier 38 contains parameters that define how a single layer in the map object will be displayed at zoom levels close to this zoom position's defined zoom position.

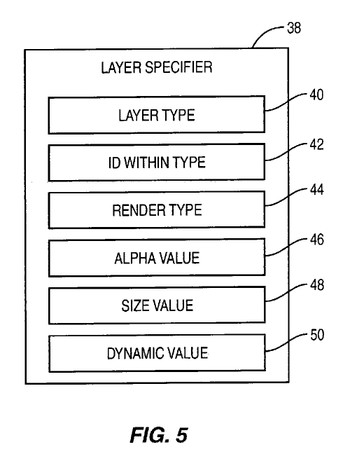

FIG. 5 illustrates the data contained within a layer specifier 38. It begins with a layer type 40 that defines the type of layer to be rendered. In one embodiment of the invention it defines a layer as a polygon, a line (typically of many segments), or superimposed text. The layer specifier 38 also includes a unique ID string 42 for the layer type defined by the layer type value 40. This ID string 42 is used along with the layer type 40 to uniquely identify this layer specifier 38.

A render type value 44 specifies a specific style of rendering for lines and polygons. This may include width of lines and other characteristics.

An alpha value 46 specifies the transparency of the rendered map elements within the layer. In one embodiment of the invention, the value ranges from 0 (completely invisible and, in fact, not rendered at all) to 255 (completely opaque). Intermediate values set levels of transparency from very transparent at low values to almost opaque at high values.

A size value 48 specifies text size, whether the text is drawn as lines (as for road names) or is presented as superimposed text (as in place names). This value in an embodiment of the invention has a different meaning depending on the type of text. For superimposed text, it defines the font size with which the text is to be rendered. For map text draw via lines (as for road names), if it is non-zero, it defines a zoom scale position that the rendering engine should use to determine how large to draw the text. If it is zero, then the text should be rendered at the normal size defined by the current zoom position.

A dynamic value 50 specifies how important the layer is to view when rendering a moving map at this zoom level. In one embodiment of the invention, the value ranges from zero to nine. A value of zero specifies that the layer will always be present when the map moves. A value of nine specifies that the layer will very likely be hidden when the map moves. Values in between range from unlikely to be hidden (low) to likely to be hidden (high). The rendering performance value set by the user determines at what dynamic value layers will disappear.

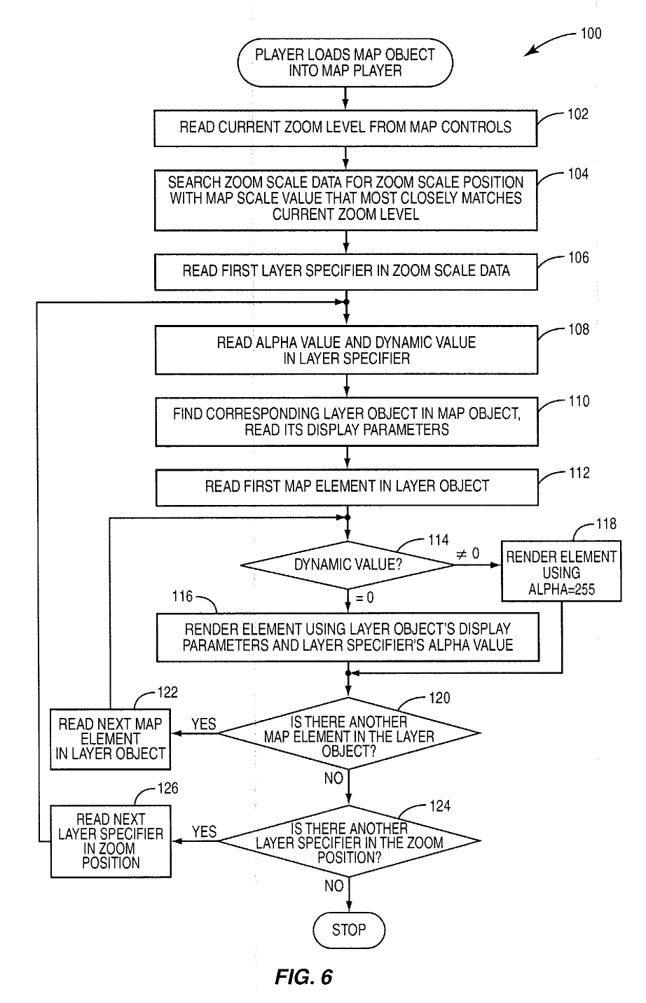

FIG. 6 illustrates the algorithm 100 the rendering engine 16 follows when a user first loads a map into the interactive map player 10.

The engine 16 begins by reading the current zoom level from the map controls 14 (block 102), a value measured in meters displayed horizontally across the map display 12. The engine 16 searches through the zoom scale data 20 to find the zoom scale position 34 with a map scale value 37 that most closely matches the map controls' 14 current map zoom level (block 104).

Once the engine 16 finds the closest zoom scale position 34 to the current zoom level, it traverses the array of layer specifiers 38 contained within the zoom scale position 34 to render each of those layers. It begins by reading the first layer specifier 38 in the zoom scale data 34 (block 106). It reads the alpha value 46 and dynamic value 50 it finds there (block 108). It then finds the corresponding layer object 24 in the map object 18 and reads the layer object's 24 display parameters 26 (block 110).

The engine 16 then traverses the array of map elements 28 in the layer object 24 to render each map element 28 within the layer. It begins with the first map element 28 (block 112), and inspects its dynamic value 50 (block 114). If the layer's dynamic value 50 equals zero (which specifies that the layer is exempt from hiding and fading during motion), the engine 16 renders the element 28 using the alpha value 46 specified by the layer specifier 38 and using the other layer rendering parameters specified there and in the layer object's 24 display parameters 26 (block 116).

If the layer's dynamic value 50 is greater than zero (which specifies that the layer may be hidden during map motion), the engine 16 renders as it would with a dynamic value 50 of zero, but overrides the alpha value 46 with a value of 255 so the element 28 is rendered in full opacity (block 118). It does this because a map when it is first loaded is considered to be at rest so all possibly hidden map elements 28 should appear in full opacity.

After the engine 16 renders a map element 28, it checks whether there is another element 28 in the layer object 24 (block 120), and if so, it reads the next map element 28 (block 122) and renders the element 28 using the rendering rules just described (blocks 114-118). This continues until there are no more elements 28 in the layer object 24 (block 120).

The engine 16 then checks for the next layer specifier 38 in the current zoom position 34 (block 124), and reads the next layer specifier 38 if found (block 126). The engine 16 renders the layer as described above (blocks 108-118). When the engine 16 is finished rendering all layers specified by the zoom position 34, the map is fully rendered and the engine 16 stops rendering until it detects a user request for map motion through the map controls 14.

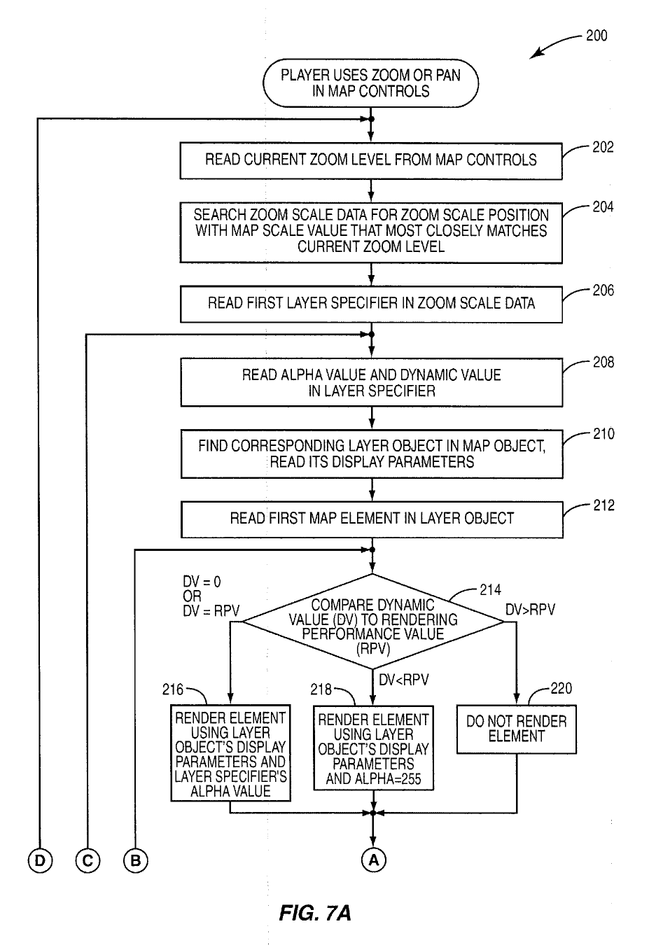

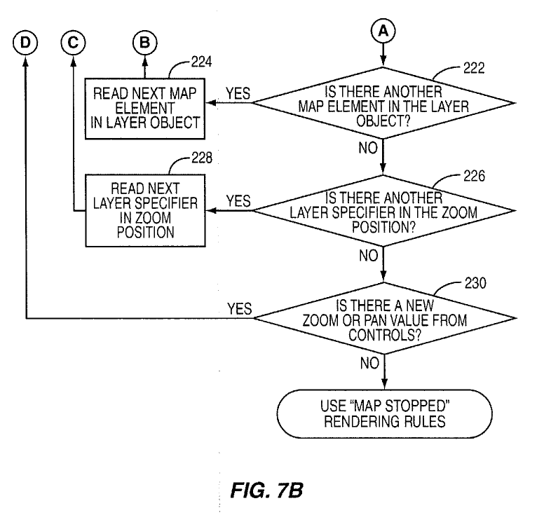

FIG. 7 illustrates the rendering engine's 16 “moving map” algorithm 200, used when a user requests to move the interactive map by using the zoom or pan controls in the map controls 14. The engine 16 is told the user's input and quickly renders a series of map frames to provide the motion requested by the user.

The engine 16 begins by reading the current zoom level from the map controls 14 (block 202). The engine 16 searches through the zoom scale data 20 to find the zoom position 34 with a map scale value 37 that most closely matches the map controls' 14 current map zoom level (block 204).

The engine 16 then traverses the array of layer specifiers 38 contained within the zoom position 34 to render each of those layers. It begins by reading the first layer specifier 38 in the zoom position 34 (block 206). It reads the alpha value 46 and dynamic value 50 it finds there (block 208). It then finds the corresponding layer object 24 in the map object 18 and reads the layer object's 24 display parameters 26 (block 210).

The engine 16 then traverses the array of map elements 28 in the layer object 24 to render each map element 28 within the layer. It begins with the first map element 28 (block 212). If the layer's dynamic value 50 equals zero (the layer is exempt from hiding and fading during motion), or if the layer's dynamic value 50 is greater than zero and equals the current rendering performance value 30 (block 214), the engine 16 renders the element 28 using the alpha value 46 specified by the layer specifier 38 and using the other layer rendering parameters 40, 42, 44, 48 specified there and in the layer object's 24 display parameters 26 (block 216). The layer-specified alpha value 46 may be one of a series specified across successive zoom positions. This series of alpha values 46 can increase or decrease to fade the layer in or out during the zoom.

If the layer's dynamic value 50 is greater than zero (the layer may be hidden during map motion) but less than the current rendering performance value 30 (the layer is a more important layer that should be rendered during motion) (block 214), the engine 16 renders as it would with a value of zero, but overrides the layer specifier's 38 alpha value 46 with a value of 255 so the element 28 is rendered in full opacity (block 218).

If the layer's dynamic value 50 is greater than zero (the layer may be hidden during map motion) and greater than the current rendering performance value 30 (a less important layer that should be hidden during map motion) (block 214), the engine 16 does not render the map element 28 at all (block 220). This reduces the number of map elements 28 rendered for this frame and increases the frame rendering speed.

After the engine 16 renders a map element 28, it checks the layer object 24 for another map element 28 (block 222), and reads the next map element 28, if found (block 224). The next element 28 is rendered as described above (blocks 214-220). When all map elements 28 in a layer object 24 have been rendered (block 222), the engine 16 checks for another layer object 24 (block 226), and if found, reads the next layer specifier 38 (228) and renders elements 28 in the layer as described above (blocks 208-222).

When the engine 16 is finished rendering all layers specified by the zoom position (block 226), this frame of the map is fully rendered. Now, the engine 16 may be fed another frame to render in a map moving sequence initiated by the use of the map controls 14 (block 230). In this case, it means that the user expects the map to continue moving, so the engine 16 renders the new frame using the “moving map” algorithm 200 once again. To do so, it reads the current zoom level from the map controls 14 (block 202) and continues as it did before.

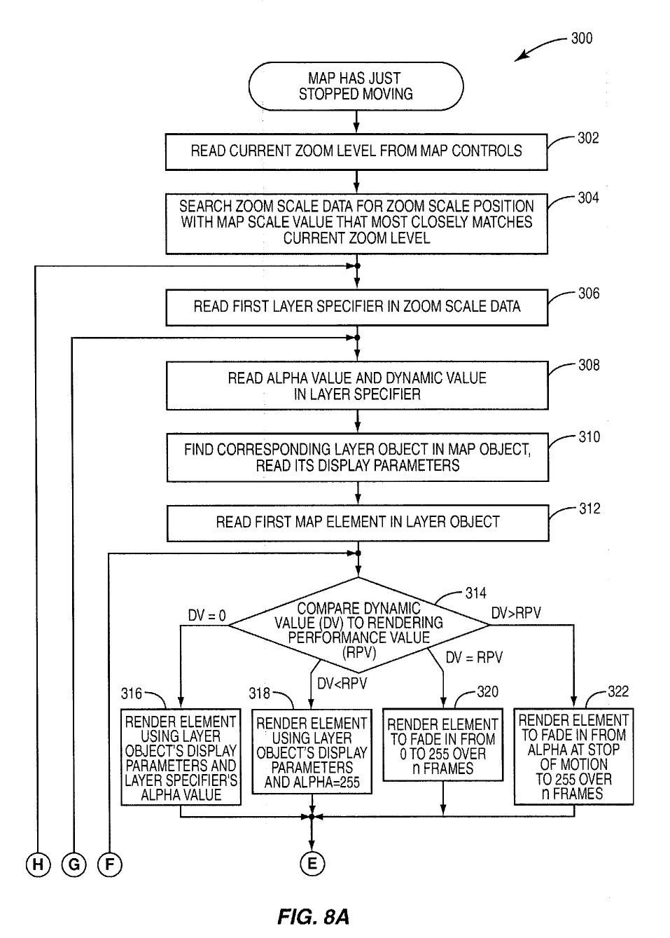

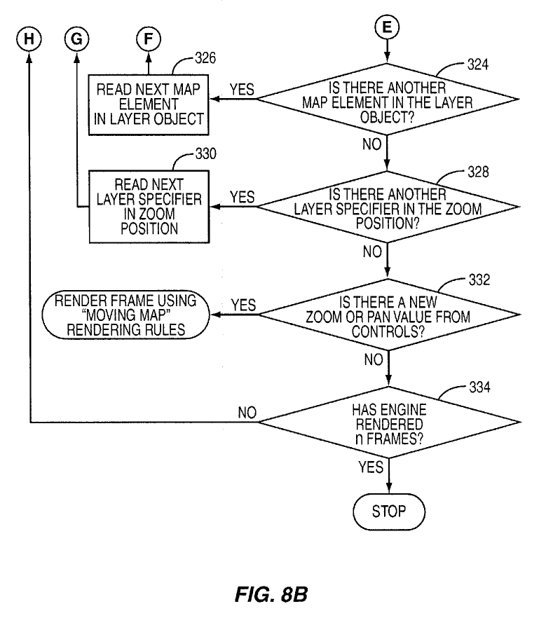

Alternatively, if the use of the map controls 14 indicates that the map should stop moving, then the engine 16 renders a set of frames using the “map stopped” algorithm 300 described below with reference to FIG. 8.

FIG. 8 illustrates the “map stopped” algorithm 300 the rendering engine 16 follows when it is sent a series of frames immediately after the map stops moving. It renders a set of n fade-in frames, where n is specified by the fade-in frames value 32 stored in the configuration data 22.

The engine 16 begins by reading the current zoom level from the map controls 14 (block 302). The engine 16 searches through the zoom scale data 20 to find the zoom position 34 with a map scale value 37 that most closely matches the map controls' 14 current map zoom level (304).

The engine 16 then traverses the array of layer specifiers 38 contained within the zoom position 34 to render each of those layers. It begins by reading the first layer specifier 38 in the zoom position 34 (306). It reads the alpha value 46 and dynamic value 50 it finds there (308). It then finds the corresponding layer object 24 in the map object 18 and reads the layer object's 24 display parameters 26 (310).

The engine 16 then traverses the array of map elements 28 in the layer object 24 to render each map element 28 within the layer. It begins with the first map element 28 (312). If the layer's dynamic value 50 equals zero (the layer is exempt from hiding and fading during motion) (block 314), the engine 16 renders the element 28 using the alpha value 46 specified by the layer specifier 38 and using the other layer rendering parameters 40, 42, 44, 48 specified there and in the layer object's 24 display parameters 26 (block 316).

If the layer's dynamic value 50 is greater than zero (the layer may be hidden during map motion) but less than the current rendering performance value 30 (a more important layer that should be rendered during motion) (block 314), the engine 16 renders the element 28 as it would with a dynamic value of zero, but overrides the alpha value 46 with a value of 255 so the element 28 is rendered in full opacity (block 318). This keeps the element 28 at the same full opacity it had while it was rendered during motion.

If the layer's dynamic value 50 is greater than zero (the layer may be hidden during map motion) and equal to the current rendering performance value 30 (this is a layer that may fade in or out during a zoom) (block 314), the engine 16 overrides the alpha value 46 specified by the layer specifier 38 to fade the element 28 in over n frames (block 320). In one embodiment, the alpha value 46 it uses for the override is determined by the formula (((255−AS)/n)*FS)+AS where AS=the alpha value 46 used to render this layer in the last frame rendered using the “moving map” algorithm, n=the fade-in frames value 32 specified in the configuration data 22, and FS=the number of this frame since the last frame rendered using the “moving map” algorithm. The practical effect of this alpha value 46, which increases over the n rendered fade-in frames, is to fade the element 28 in from its moving alpha value 46 to full opacity. The formula may be altered as required or desired to effect a more or less rapid fading effect.

If the layer's dynamic value 50 is greater than zero (the layer may be hidden during map motion) and greater than the current rendering performance 30 value (a less important layer that should be hidden during map motion) (block 314), the engine 16 overrides the alpha value 46 specified by the layer specifier 38 to fade the element in over n frames (block 322). In one embodiment, the alpha value 46 it uses for the override is determined by the formula ((255/n)*FS) where n=the fade-in frames value 32 specified in the configuration data 22, and FS=the number of this frame since the last frame rendered using the “moving map” algorithm 200. The practical effect of this alpha value 46, which increases over the n rendered fade-in frames, is to fade the element 28 in from an alpha value 46 of zero (completely hidden during motion) to full opacity. The formula may be altered as required or desired to effect a more or less rapid fading effect.

After the engine 16 renders a map element 28, it checks the layer object 24 for another map element 28 (block 324). If found, it reads the next map element 28 (block 326) and renders it using the rendering rules just described (blocks 314-322). When all the map elements 28 in a layer object 24 have been rendered (block 324), the engine 16 checks for the next layer specifier 38 (block 328). If found, it reads the next layer specifier 38 (block 330), and renders the map elements 28 in that layer (blocks 308-324). When the engine 16 is finished rendering all layers specified by the zoom position 34 (block 328), this frame of the map is fully rendered.

Now, the rendering engine 16 is fed the next frame to be rendered. If the user has initiated a new zoom or pan before completion of the fade-in sequence (block 332) the next frame is the first frame in a new “map moving” sequence 200. Otherwise, the next frame is the next in the fade-in sequence (as determined by the map still being in a ‘not moving’ state). The engine 16 checks to see if it has rendered the n frames specified by the fade-in frames value 32 (block 334). If it has not, the engine 16 then renders another frame using the “map stopped” algorithm 300 (blocks 306-334). If it has, then the engine 16 stops rendering.

The “map moving” and “map stopped” algorithms 200, 300 allow map elements 28 having low priority or importance, as reflected in the dynamic value 50 of the layer specifier 38, not to be rendered when zooming or panning the map display 12. This increases the efficiency of the rendering engine 16 by reducing the number map elements 28 to render, allowing the engine 16 to render map display 12 frames at a higher rate, providing the illusion of smooth motion to the user. The not-rendered map elements 28 fade in by increasing their opacity when the map display 12 reaches the desired zoom level or displayed location.

It is well known in the mapping arts to render map elements 28 when a map display 12 is zoomed in, which are not rendered when the display 12 is zoomed out. This prevents detailed information from cluttering the display at low zoom levels. Prior art map display systems 10 simply define a zoom level or range of zoom levels at which a class of map elements 28 such as a layer—will be rendered. As a user zooms in a map display 12, at the requisite level of zoom these map elements 28 suddenly appear on the display 12, and just as suddenly disappear as the user zooms out. This can be startling, and destroys the illusion of smooth motion during zoom operations.

According to one embodiment, layers of map elements 28 that are to be displayed only in a subset of zoom levels fade in as the user zooms the map display 12 into to the subset, and fade out as the user zooms out of it. This is accomplished by specifying a high alpha value 46 (such as 255) of a layer for each zoom position 34 in the subset of zoom levels in which the layer is rendered, and specifying decreasing alpha values 46 for the zoom levels adjacent the subset.

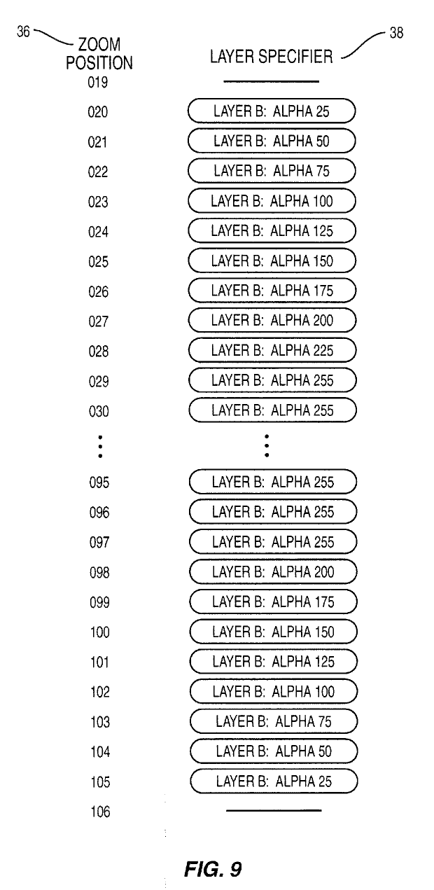

FIG. 9 illustrates how layer specifiers 38 work to specify how a layer of map elements 28 fade in and/or fade out over a zoom. The set of zoom positions 34 in which the layer appears are defined by zoom position index values 36 that range in this example from 020 to 105, out of a total range of values from 001 (zoomed out all the way) to 150 (zoomed in all the way).

The layer of map elements 28 in this example has the name “Layer B.” No layer specifiers 38 for Layer B appear in zoom positions 34 having an index value 36 in the range from 001 through 019, so the rendering engine 16 will not draw Layer B map elements 28 when the user is zoomed in to (or near) these zoom positions 34. A Layer B layer specifier 38 first appears in zoom position 34 having an index value 36 of 020, with an alpha value 46 of 25 (very transparent). A series of Layer B layer specifiers 38 appears across zoom positions 34 having index values 36 of 020 through 028, with alpha values 46 that increase gradually as the zoom position 34 index value 36 increases, until it reaches the maximum alpha value 46 of 255 (completely opaque). At the zoom position 34 having an index value 36 of 098, the alpha value 46 begins to decrease until it reaches an alpha value 46 of 25 in zoom position 34 having an index value 36 of 105. In zoom positions 34 having index values 36 from 106 to 150, a Layer B layer specifier 38 does not appear, so Layer B is not rendered in (or near) those zoom positions 34.

Operation of this embodiment during a zoom operation can be seen by assuming the Layer B layer specifier 38 has a dynamic value 50 of zero, and following the algorithms 100, 200. In the initial display (FIG. 6), the dynamic value 50 of zero is detected at block 114, and block 116 is executed in response, rendering each element using the layer specifier's alpha value 46. This will render map elements 28 in Layer B using the alpha values 46 in FIG. 9.

Consider an initial display 12 at a zoom position 34 having an index value 36 of 106 or greater. As the user zooms in (FIGS. 7A-7B), the dynamic value 50 of zero is detected at block 214, and block 216 is executed in response, rendering each element using the layer specifier's 38 alpha value 46. Accordingly, the map elements 28 in Layer B are rendered with increasing opacity (i.e., alpha values 46 changing from 25 to 225), creating the illusion that they are fading in, and providing a subjective feeling of smooth motion. Similarly, as the user continues to zoom in to zoom positions 34 having index values 028-020 and lower, the Layer B map elements 28 gradually fade out of the display by being rendered with decreasing alpha values 46, and at zoom positions 34 index value 019, are not rendered at all.

Another problem with interactive maps, related to zoom position, is the display of text at an appropriate size. It is often desirable to zoom a map display 12 out to view a large area. At this zoom position 34, text labels identifying, e.g., street names, are too small to easily read. According to one or more embodiments, such text labels are briefly enlarged when a user “mouses over” the label, or hovers the mouse pointer over a small label. The label returns to the smaller size when the user moves the mouse pointer off of the label. In this manner, a variety of labels may easily be read without the need to change zoom levels.

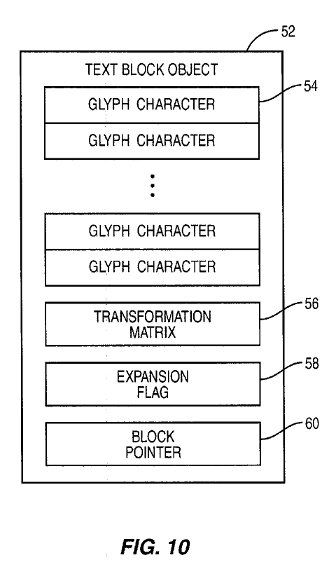

FIG. 10 illustrates a data structure for storing vector-drawn text within the map object 18 according to one embodiment of the present invention. A text block object 52 contains a set of one or more glyph characters 54. Each glyph character 54 comprises a set of specifications for drawing a single text character. Those specifications are typically a set of points and curve values that define the character outline.

A text block object 52 also includes a transformation matrix 56 that specifies how the string of one or more glyph characters 54 will be sized, rotated, and located within the map. The text block object 52 also includes an expansion flag 58 that specifies whether or not the characters in the block should be expanded during rendering. Finally the text block object 52 includes a block pointer 60, which is a pointer to another text block object 52. This pointer 60 is used to tie a group of text block objects 52 together as a text label: all text block objects 52 that point to the same initial text block object 52 belong to the same label.

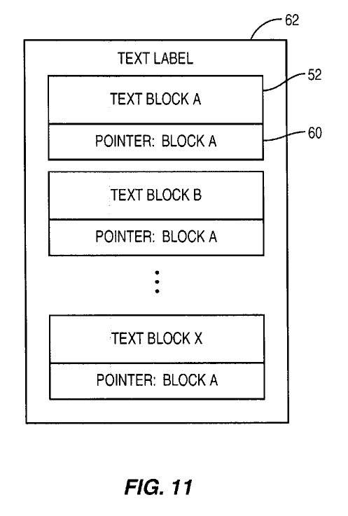

FIG. 11 illustrates a set of text block objects 52 that constitute a single text label 62. Each text block 52 in the set has its pointer 60 set to point to the first text block 52 in the set: text block A in this example. The drawing logic associated with the rendering engine will recognize these as a set because of their identical pointers 60.

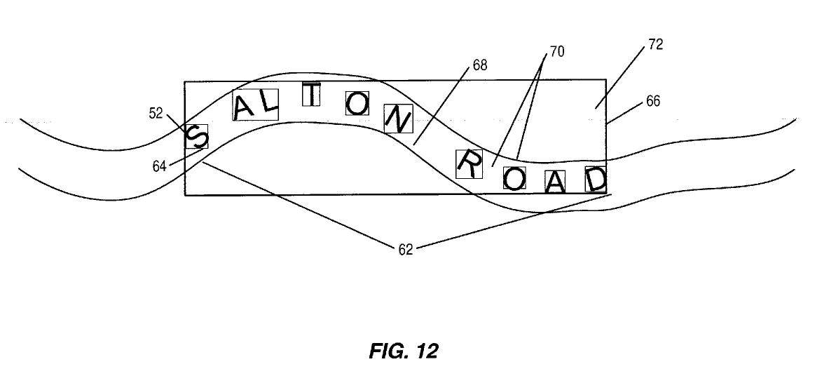

An example of a text label 62, depicted in FIG. 4, is a set of nine text blocks 52 that each contain one or more characters: “S.” “AL ,” “T.” “O.” “N.” “R.” “O.” “A,” “D.” Each text block 52 contains a transformation matrix 56 that places the blocks 52 in sequence, rotating them as necessary to bend the text to fit a road in this example. FIG. 12 illustrates the text label 62 as it is displayed along a road in the map display 12. The text label 62 is composed of a set of text blocks 52, each rotated, sized, and placed individually to create a road name that fits within the road boundaries. Each text block 52 has a text block bounding rectangle 64 that defines the topmost, bottommost, leftmost, and rightmost boundaries of the character glyph in the text block 52.

The full text label 62 has a text label bounding rectangle 66 that defines the topmost, bottommost, leftmost, and rightmost boundaries of all the text blocks 52 within the text label 62. The text label bounding rectangle center point 68 is a point midway between the top and bottom and midway between the left and right edges of the text label bounding rectangle 66. The center point 68 is used to help place the text label 62 when it is expanded.

The map features beneath the text label 62 are rendered in a map display 12 using different colors. The colors used to render the geographic feature which the text label 62 names are called expansion inclusion colors 70. The colors used to render map areas that are not named features are called expansion exclusion colors 72.

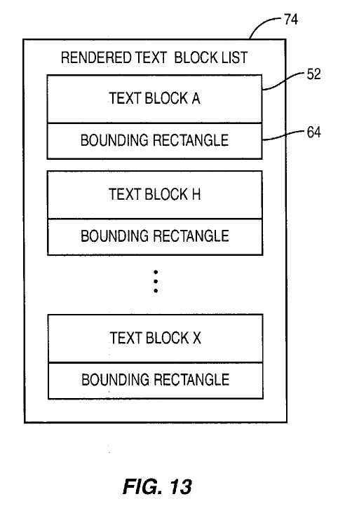

FIG. 13 illustrates how the drawing logic associated with the rendering engine 16 keeps track of text blocks 52 currently rendered in the map display 12. It maintains a rendered text block list 74 that contains a set of text blocks 52 that are currently drawn in the map display 12. Each text block 52 is associated with a bounding rectangle 64 that defines the edges of the text block 52.

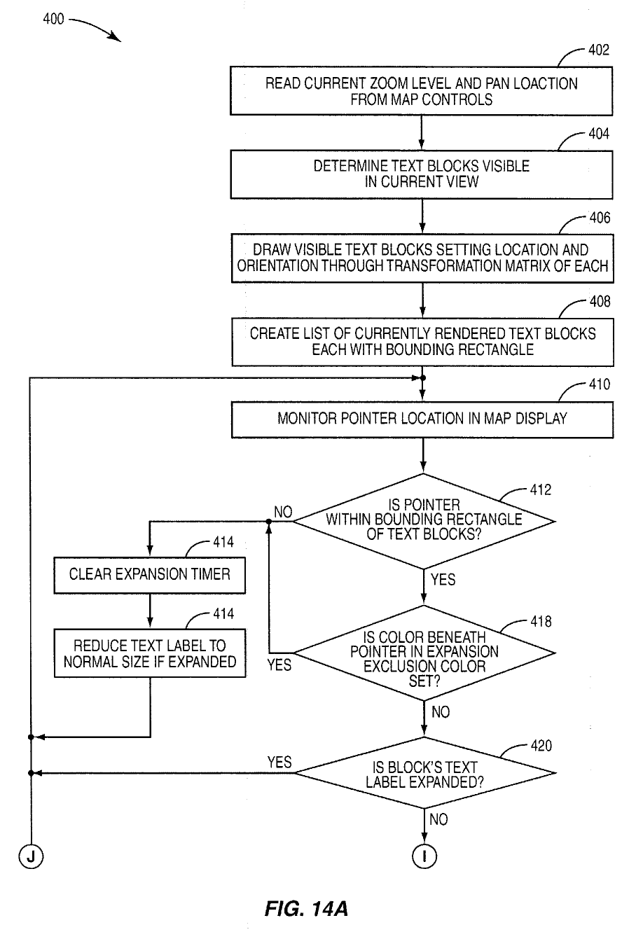

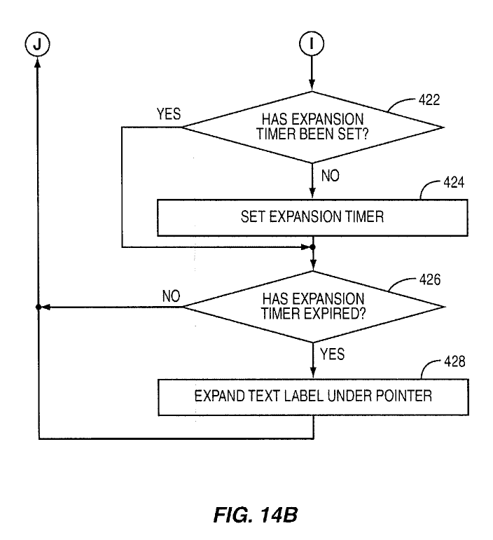

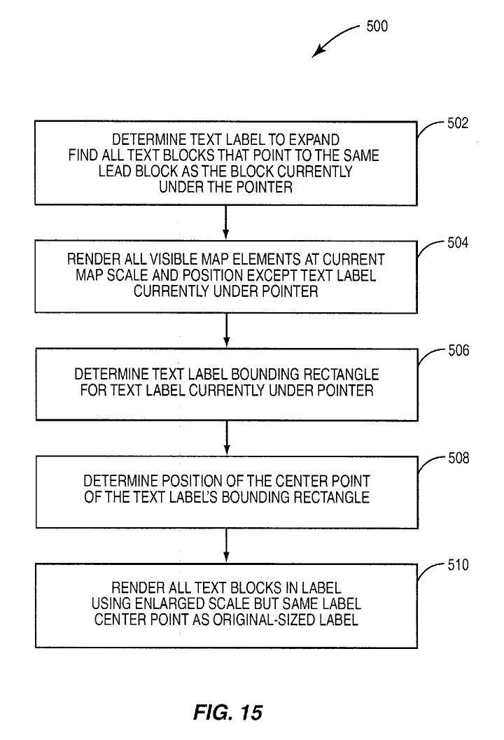

FIG. 14 illustrates the algorithm 400 the drawing logic associated with the rendering engine 16 follows when it renders map text and then monitors the pointer position as the user moves his mouse pointer over the map display 12. The logic reads the current zoom level and pan location from the map controls 14 (block 402), determines which text blocks 52 should be visible in the map display 12 at that zoom level and pan location (block 404), and then draws those text blocks 52 in the map display 12 using each block's 52 transformation matrix to determine the size, rotation, and placement of the block 52 (block 406). The logic creates a list of all text blocks 52 rendered in the current map display 12, each block 52 with an associated bounding rectangle 64 (block 408).

The drawing logic then monitors the location of the mouse pointer within the map display 12 (block 410). The hover duration of the mouse pointer over an expandable text label is tracked with an expansion timer. If the pointer does not fall within the bounding rectangle 64 of any text block 53 in the display 12 (block 412), the expansion timer is cleared (block 414). The logic also reduces the text label 62 if it is already expanded because the pointer is no longer over the label 62 and the label should not be expanded (block 416). The logic then continues to monitor the location of the mouse pointer (block 410).

If the pointer does fall within a text block's 52 bounding rectangle 64 (block 412), the drawing logic then checks the color beneath the pointer. If the color is in the expansion exclusion color set 72 (block 418), then the logic acts as if the pointer is not in a bounding rectangle 64 (block 412), clearing the expansion timer if set (block 414), reducing text label size if expanded (block 416), and then continuing to monitor mouse pointer location (block 410).

If the color is not in the expansion exclusion color set 72 (block 418), then the logic assumes the text block 52 under the pointer can be expanded along with all the other text blocks 52 within the same text label 62. If the text label 62 is already expanded (block 420), then the logic need not do anything more and goes back to monitoring the mouse pointer location (block 410).

If the text label has not yet been expanded (block 420), the drawing logic checks the expansion timer. If the timer has not been set (block 422), the logic sets the timer (block 424) which counts down until it is time to expand the text label 62. This timer ensures that text labels 62 do not expand prematurely when the user quickly rolls the pointer over the label 62 on the way to some other name. After checking to see if the expansion timer is set (block 422), the drawing logic checks to see if the expansion timer has expired (block 426). If it has, the logic then expands the text label 62 under the pointer (block 428), using a procedure 500 described in the FIG. 15. In all cases the logic goes back to monitoring the mouse pointer in the map display 12 (block 410).

FIG. 15 illustrates the algorithm 500 the drawing logic associated with the rendering engine 16 follows when it expands a text label 62. It first determines the extent of the text label 62. It looks at the text block 52 under the mouse pointer to read the block's pointer 60. It then finds all other blocks 52 that have the same pointer 60 value. These blocks 52 constitute the components of the text label 62 under the pointer (block 502).

To expand the text label 62, the drawing logic must use the rendering engine 16 to redraw the entire map. To do so, the rendering engine 16 renders all visible map elements 28 at the current zoom level and displayed position except for the text label 62 currently beneath the mouse pointer (block 504). It then determines the text label bounding rectangle 66 for the text label 62 under the pointer (block 506) and calculates the position of the center point 68 of the bounding rectangle (block 508).

The drawing logic then uses the text label bounding rectangle center point 68 to render the expanded text label 62: it uses the rendering engine 16 to render all the blocks 52 in the text label using an enlarged scale, but uses the previously calculated center point 68 for the enlarged text label 62 (block 510). This ensures that the expanded text label 62 is not off center in the map display 12, which is at a small scale.

When the user moves the mouse off of the text label, the rendering engine 16 again renders the entire map, with the text label 62 rendered at an appropriate (i.e., non-expanded) size, as diagramed in FIG. 14.

In this manner, a user may utilize a map at a zoom-out level, for example, viewing a large part of a city. The user may pause a pointer over a text label 62 that is too small to read, such as a street name, and the text label 62 is expanded for the user's convenience. Thus a map user may read a wide array of text labels on the map, without sacrificing the “big picture” map view that provides the user's desired zoom level, and without performing the tedious operations of zooming in to read a text label and then zooming back out to view the map.

An embodiment of the invention may comprise a machine-readable medium having stored thereon instructions which cause a processor to perform operations as described above. In other embodiments, the operations might be performed by specific hardware components that contain programmable or hardwired logic. Those operations might alternatively be performed by any combination of programmed computer components and custom hardware components.

A machine-readable medium may include any mechanism for storing or transmitting information in a form readable by a machine (e.g., a computer), not limited to Compact Disc Read-Only Memory (CD-ROMs), Read-Only Memory (ROMs), Random Access Memory (RAM), Erasable Programmable Read-Only Memory (EPROM), and a transmission over the Internet.

As used herein, a map element is a single logical element drawn within a map. A map uses a map element to present a geographical feature or information about a geographical feature. Examples of map elements include roads, parks, shorelines, road names, area names, and the like.

As used herein, a layer is a group of map elements of the same type that are all defined to have the same presentation properties during interactive map display.

As used herein, a frame is one complete rendering of an interactive map. A frame has a single zoom level and displayed location. Multiple frames in succession create the illusion of motion in a map display.

As used herein, a Glyph character is a text character defined as a collection of lines defining the outline shape of that character.

As used herein, the term “or” has the meaning of the logical OR operator (as distinct from the logical XOR operator). That is, “A or B” means A alone, B alone, or both A and B together (as distinct from “A XOR B,” which means A and not B, or B and not A, but excludes both A and B together). In other words, the term “or” has the same meaning as the construct “and/or.” In particular, the phrase “zoom or pan” means a zoom operation, a pan operation, or both a zoom and pan operation together (i.e., changing both the zoom level and the displayed location simultaneously).

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the spirit and scope of the invention. The present embodiments are therefore to be construed in all aspects as illustrative and not restrictive and all changes coming within the meaning and equivalency range of the appended claims are intended to be embraced therein.

What is claimed is:

1. A method of efficiently zooming or panning an interactive map display to present the illusion of smooth motion, the display comprising a plurality of map elements arranged in layers, each layer having predetermined display properties, comprising:
accepting a rendering performance value;
accepting map control commands from a user;
in response to the map control commands, zooming or panning the map display by successively rendering frames of the map, each frame having an incrementally different zoom level or displayed location, to create the illusion of smooth motion;
during the map display zoom or pan, selectively rendering map elements in each frame in response to the predetermined display properties associated with each element's layer, the zoom level, and the rendering performance value, such that one or more relatively unimportant map elements are not displayed to reduce the computational task of rendering the frame; and
upon completion of the zoom or pan, fading in the relatively unimportant map elements that were not displayed during the zoom or pan, by successively rendering frames having the same zoom level and displayed location, the unimportant map elements rendered in increasing opacity in each successive frame.

2. The method of claim 1 wherein the rendering performance value is determined based on the computational power of a map display rendering engine.

3. The method of claim 1 wherein the predetermined display properties associated with each layer include a dynamic value, and wherein selectively rendering map elements in each frame, during a zoom or pan, comprises comparing a layer's dynamic value with the current rendering performance value to determine whether map elements in the layer should be rendered during the zoom or pan.

4. The method of claim 1 wherein the predetermined display properties associated with each layer include an alpha value specifying the degree of opacity with which map elements in the layer should be displayed in a still map display.

5. The method of claim 4 wherein a plurality of predetermined zoom positions are defined, each zoom position including a plurality of layer specifiers containing the predetermined display properties and map elements to be rendered at that zoom position.

6. The method of claim 5, further comprising setting the alpha value in corresponding layer specifiers at a plurality of adjacent zoom positions to an incrementally changing value so as to fade in map elements in the layer by incrementally changing the degree of opacity with which the map elements in the layer are rendered during a zoom operation.

7. The method of claim 1, further comprising
displaying an interactive map at a first zoom level and displayed location;
monitoring the position of a mouse pointer in the display; and
in response to detecting that the mouse pointer has remained over a text label for a predetermined duration, expanding the size of the text label while maintaining the rest of the display at the first zoom level.

8. The method of claim 7 wherein detecting that the mouse pointer has remained over a text label for a predetermined duration comprises detecting that the mouse pointer is over a bounding box of a text character in the label for the predetermined duration.

9. The method of claim 8 wherein detecting that the mouse pointer is over a bounding box of a text character in the label further comprises detecting that the mouse pointer is not over a color in an expansion exclusion color set.

10. The method of claim 7 further comprising reducing the size of the expanded text label upon detecting that the mouse pointer has moved off of the text label.

11. A computer readable medium including one or more computer programs operative to cause a computer to display an interactive map, the computer programs causing the computer to perform the steps of:
accepting a rendering performance value;
accepting map control commands from a user;
in response to the map control commands, zooming or panning the map display by successively rendering frames of the map, each frame having an incrementally different zoom level or displayed location, to create the illusion of smooth motion;
during the map display zoom or pan, selectively rendering map elements in each frame in response to the predetermined display properties associated with each element's layer, the zoom level, and the rendering performance value, such that one or more relatively unimportant map elements are not displayed to reduce the computational task of rendering the frame; and
upon completion of the zoom or pan, fading in the relatively unimportant map elements that were not displayed during the zoom or pan, by successively rendering frames having the same zoom level and displayed location, the unimportant map elements rendered in increasing opacity in each successive frame.

12. The computer readable medium of claim 11 wherein the computer programs determine the rendering performance value based on the computational power of a computer executing them.

13. The computer readable medium of claim 11 wherein the predetermined display properties associated with each layer include a dynamic value, and wherein selectively rendering map elements in each frame, during a zoom or pan, comprises comparing a layer's dynamic value with the current rendering performance value to determine whether map elements in the layer should be rendered during the zoom or pan.

14. The computer readable medium of claim 11 wherein the predetermined display properties associated with each layer include an alpha value specifying the degree of opacity with which map elements in the layer should be displayed in a still map display.

15. The computer readable medium of claim 14 wherein a plurality of predetermined zoom positions are defined, each zoom position including a plurality of layer specifiers containing the predetermined display properties and map elements to be rendered at that zoom position.

16. The computer readable medium of claim 15, further comprising setting the alpha value in corresponding layer specifiers at a plurality of adjacent zoom positions to an incrementally changing value so as to fade in map elements in the layer by incrementally changing the degree of opacity with which the map elements in the layer are rendered during a zoom operation.

17. The computer readable medium of claim 11, the computer programs further causing the computer to perform the steps of:
displaying an interactive map at a first zoom level and displayed location;
monitoring the position of a mouse pointer in the display; and
in response to detecting that the mouse pointer has remained over a text label for a predetermined duration, expanding the size of the text label while maintaining the rest of the display at the first zoom level.

18. The computer readable medium of claim 17 wherein detecting that the mouse pointer has remained over a text label for a predetermined duration comprises detecting that the mouse pointer is over a bounding box of a text character in the label for the predetermined duration.

19. The computer readable medium of claim 18 wherein detecting that the mouse pointer is over a bounding box of a text character in the label further comprises detecting that the mouse pointer is not over a color in an expansion exclusion color set.

20. The computer readable medium of claim 17 further comprising reducing the size of the expanded text label upon detecting that the mouse pointer has moved off of the text label.
